(19) United States
(12) Patent Application Publication
(10) Pub. No.: US 2009/0045329 A1
(43) Pub. Date: Feb. 19, 2009

(54) Downhole Tools Having Combined D-D and D-T Neutron Generators

(75) Inventor: Christian Stoller, Princeton Junction, NJ (US)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation, Sugar Land, TX (US)

(21) Appl. No.: 11/839,757

(22) Filed: Aug. 16, 2007

(51) Int. Cl. G01V 5/10

(52) U.S. Cl. 250/269.4

(57) ABSTRACT

A nuclear tool includes a tool housing; a d-D neutron generator disposed in the tool housing; a d-T neutron generator disposed in the tool housing; and, optionally, a control circuit for controlling pulsing of the d-D neutron generator and the d-T neutron generator. A method for well-logging using a nuclear tool includes disposing the nuclear tool in a wellbore penetrating a formation; pulsing a d-D neutron generator to emit neutrons at a first energy level into the formation; pulsing a d-T neutron generator to emit neutrons at a second energy level into the formation; and measuring signals returning from the formation.

### BACKGROUND OF INVENTION

1. Field of Invention

This invention relates tools for the determination of formation porosity; particularly, this invention relates to nuclear tools having neutron generators.

2. Background Art

In hydrocarbon exploration and production, it is important to determine whether an earth formation contains hydrocarbon and how much hydrocarbon is in the formation. Underground hydrocarbons, as well as water, are typically contained in pore space in the formations. Neutron “porosity” tools are traditionally used to determine the amount of hydrocarbon and water present in pore spaces of earth formations because of their unique abilities to detect such fluids.

A neutron tool contains a neutron-emitting source (either a chemical source or a neutron generator) and one or more axially spaced detectors that respond to the flux of impinging neutrons resulting from the interactions of neutrons with nuclei within the borehole and formation in the vicinity of the borehole. The basic concept of a neutron porosity tool is predicated on the fact that (a) hydrogen is the most effective moderator of neutrons and that (b) most hydrogen found in earth formations is contained in liquid in the pore space of the formation, either as water or as liquid hydrocarbon or gas. For neutrons emitted with a fixed energy by the source, the count rates recorded by the neutron detectors decrease as the volumetric concentration of hydrogen (e.g., porosity) increases.

FIG. 1 shows a simplified schematic illustrating a wireline neutron logging operation. As shown in FIG. 1, a neutron tool 11 is disposed in a wellbore 12. The neutron tool 11 includes a neutron source 13 and one or more neutron detectors 14. The neutron source, which may be a chemical source or an electronic neutron generator, emits neutrons into the formation 15 surrounding the wellbore 12. The emitted neutrons traverse the formation 15 and interact with matter in the formation. As a result of such interactions, the neutrons lose some of their energy. Consequently, the neutrons may arrive at the detector 14 with Sower energies. By analyzing the response of the detectors to these neutrons, it is possible to deduce the properties of the surrounding formations.

Traditional neutron tools with chemical sources are able to measure the porosity of a formation in the form of a thermal neutron porosity reading. The chemical source typically relies on α-beryllium reactions in a ²⁴¹Am—Be mixture. Beryllium releases a neutron of approximately 4 MeV when struck by an alpha particle, which is produced by the americium. These high-energy neutrons interact with nuclei in the formation and become slowed mainly by elastic scattering to near thermal energies. The slowing-down process is dominated by scatteing of neutrons by hydrogen. At thermal energies, the neutrons diffuse through the material until they undergo thermal capture. Capture is dominated by thermal neutron absorbers, such as chlorine or iron.

FIG. 2A shows one example of a chemical source neutron tool (e.g., CNL® from Schlumberger Technology Corp., Houston, Tex.). As shown in FIG. 2A, the chemical source neutron tool 20 includes a chemical source 25, which includes a radioactive material, such as AmBe. The chemical source neutron tool 20 also includes a near detector 24 and a far detector 22 to provide a countrate ratio, which is used to calculate the porosity of a formation. The near detector 24 and far detector 22 are thermal detectors, hi addition, the tool 20 includes shielding materials 23 that prevent the neutrons generated by the chemical sources from directly reaching the detectors, minimizing the interference from the neutron source 25.

Neutron tools using chemical sources have been around for a long time. As a result, users are more familiar with the thermal neutron porosity measurement acquired with chemical source neutron tools. In addition, petrophysicists typically use thermal neutron porosity for specific minerals as part of their formation analysis. However, chemical sources are less desirable due to their constant emission of radiation and strict government regulations. In addition, these chemical sources are becoming scarce. Therefore, there is a need to develop neutron tools that do not rely on chemical sources.

In response to the desire to move away from chemical source neutron tools, some modern neutron tools have been equipped with electronic neutron sources, or neutron generators (minitrons). Neutron generators contain compact linear accelerators and that produce neutrons by fusing hydrogen isotopes together. The fusion occurs in these devices by accelerating either deuterium (²D) or tritium (³T), or a mixture of these two isotopes, into a metal hydride target, which also contains either deuterium (²D) or tritium (³T), or a mixture of these two isotopes. Fusion of deuterium nuclei (²D+²D) results in the formation of a ³He ion and a neutron with a kinetic energy of approximately 2.4 MeV. Fusion of a deuterium and a tritium atom (²D+³T) results in the formation of a ⁴He ion and a neutron with a kinetic energy of approximately 14.1 MeV.

These neutrons, when emitted into formations, interact with matter in the formations and gradually lose energy. This process is referred to as slowing down. The slowing-down process is dominated by hydrogen, and is characterized by a slowing-down length. Eventually, the high-energy neutrons are slowed down enough to become epithermal neutrons or thermal neutrons. Thermal neutrons typically have an average energy corresponding to a kinetic energy of 0.025 eV at room temperature, while epithermal neutrons typically have energies corresponding to kinetic energies in the range of 0.4-10 eV. However, some epithermal neutrons may have energies as high as 1 keV. One of ordinary skill in the art would appreciate that these energy ranges are general guidelines, rather than dear-cut demarcations. The slowed-down neutrons are typically detected by detectors on the tools, which may include fast neutron detectors, epithermal neutron detectors, and thermal neutron detectors.

FIG. 2B shows one example of an electronic source neutron tool (e.g., APS® from Schlumberger Technology Corp., Houston, Tex.). Examples of such tools can be found in U.S. Pat. No. 6,032,102 issued to Wijeyesekera et al., and in U.S. Pat. No. Re. 36,012 issued to Loomis et al. These patents are assigned to the present assignee and are incorporated by reference in their entirety. As shown in FIG. 2B, the electronic source neutron tool 21 uses an electronic neutron source to produce high-energy (e.g., 2.4 or 1.4 MeV) neutrons. The high-energy neutrons emitted into formations are slowed to epithermal and thermal energies by interactions with matter (nuclei) in the formations. The epithermal or thermal neutrons are detected by detectors on the neutron tool 21, such as near detector 26, array detector 27, and far detector 29. By measuring epithermal neutrons, the detector responses are primarily dominated by the hydrogen content in the formation, without complication from neutron absorbers. Thus, the electronic neutron tool 21 may conveniently provide measurements for hydrogen index. In addition, the neutron tool 21 may also include an array thermal detector 28 to detect thermal neutrons that returned from the formation. The epithermal neutron and thermal neutron measurements obtained with this tool can be used to derive various formation parameters.

The electronic source neutron tools are generally operated in a pulsed mode to emit short duration neutron bursts. These bursts have a sufficient duration to enable relatively accurate measurement of density (through spectral analysis of inelastic gamma rays) and accurate measurement of porosity (through measurement of neutron count rates). One or more neutron detectors appropriately spaced from the source are used to make the neutron count rate measurements. A gamma ray detector may also be used to make the inelastic gamma ray measurements. The short duration bursts are repeated for a selected number of times and the measurements made in appropriate time windows during and/or after each neutron burst are summed or stacked to improve the statistical precision of the measurements made therefrom. These instruments may also be adapted to measure neutron capture cross section of the earth formations.

The availability of the newer electronic source neutron tools has shown that having different neutrons at different energy levels can provide measurements that are not readily available from the chemical source neutron tools. Therefore, it is desirable to further design nuclear tools having different energy sources.

### SUMMARY OF INVENTION

One aspect of the invention relates to nuclear tools for formation logging. A nuclear tool in accordance with one embodiment of the invention includes a tool housing; a d-D neutron generator disposed in the tool housing; a d-T neutron generator disposed in the tool housing; and, optionally, a control circuit for controlling pulsing of the d-D neutron generator and the d-T neutron generator. The nuclear tool may also include one or more detectors, such as fast neutron detectors, epithermal neutron detectors, thermal neutron detectors, or gamma-ray detectors.

Another aspect of the invention relates to methods for well-logging using a nuclear tool. A method in accordance with one embodiment of the invention includes disposing the nuclear tool in a wellbore penetrating a formation; pulsing a d-D neutron generator to emit neutrons at a first energy level into the formation; pulsing a d-T neutron generator to emit neutrons at a second energy level into the formation; and measuring signals returning from the formation. The signals may include neutron and/or gamma-ray signals. The pulsing of the d-D and d-T neutron generators may be performed according to a specific pulsing scheme. The method may further include deriving one or more formation properties from the detected signals.

Other aspects and advantages of the invention will be apparent from the following description and the appended claims.

### BRIEF DESCRIPTION OF DRAWINGS

FIG. 1 shows a conventional nuclear logging tool disposed in a wellbore.

FIGS. 2A and 2B show schematics of a conventional chemical source neutron tool and a conventional electronic source tool, respectively.

FIG. 3 shows a schematic of an electronic neutron generator.

FIGS. 4A and 4B show schematics illustrating two different arrangements of the neutron generators in accordance with embodiments of the invention.

FIGS. 5A-5C show schematics of exemplary pulsing schemes that can be used with tools of the invention.

FIG 6 shows a flow chart illustrating a method of formation logging using a tool of the invention.

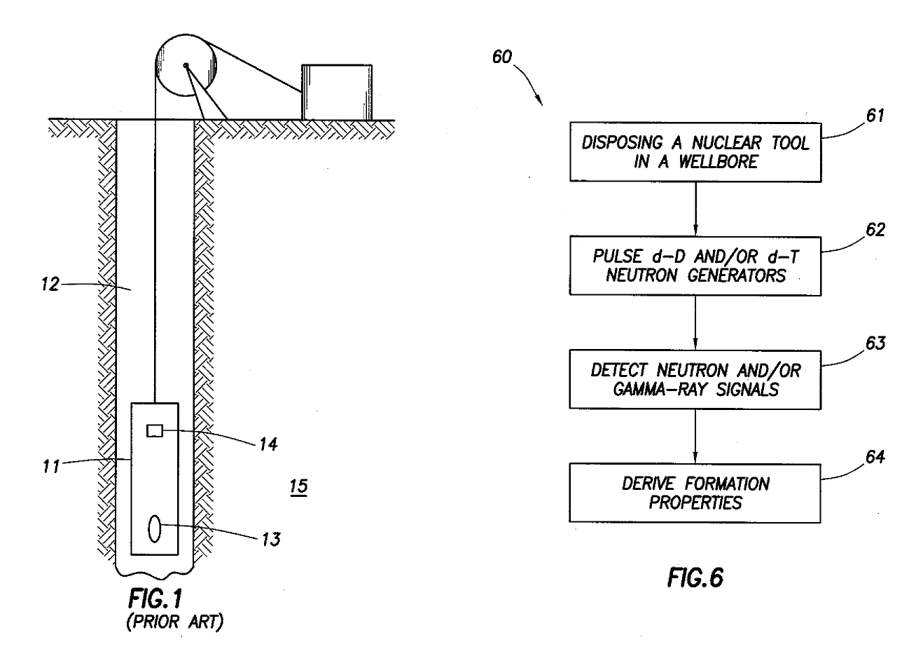

### DETAILED DESCRIPTION

Embodiments of the invention relate to electronic neutron sources and tools having electronic neutron sources. As noted above, there are two different types of electronic neutrons generators currently in use with downhole neutron tools. ²D-²D and ²D-³T neutron generators. In accordance with embodiments of the invention, a nuclear tool may include two different types of electronic neutron sources, ²D-²D and ²D-³T. Such tools, which may be used for neutron and/or gamma-ray measurements, typically include one or more detectors, such as thermal neutron detectors, epithermal neutron detectors, fast neutron detectors, and gamma detectors.

As noted above, electronic neutron generators contain compact linear accelerators that produce neutrons by fusing hydrogen isotopes (²D, ³T, or a mixture of both) FIG. 3 shows a schematic illustrating a neutron generator that is commonly used in neutron tools. As shown in FIG. 3, the neutron generator 30, which is typically housed in a ceramic tube containing tritium and deuterium at low pressure, includes a source 31 and a target 32. In a typical device, a low pressure deuterium (²D ) or tritium (³T) gas mixture is generated by heating a filament 34 that serves as the gas reservoir. The gas is then ionized in the ion source 31. The figure depicts a Penning type ion source 31 with a magnet 33. However, other types of ion sources may be used. The deuterium (²D) or tritium (³T) ions thus generated are accelerated towards the target 32, which also contains the deuterium (²D) or tritium (³T) isotopes as metal hydrides. The acceleration of the ions may be a high voltage potential. The generation of neutrons and the operation of the neutron generator 30 may be under the control of a circuit 35, which may be housed within the same tool section or in a different tool section. In addition, the neutron generator 30 may include one or more neutron flux monitor 36.

There are several types of electronic neutron generators; one is a d-D neutron generator another one is a d-T neutron generator. There are other types of nuclear reactions that can be used for the generation of neutrons, which do not yet have practical applications in downhole logging. When high-speed ²D and ³T ions collide with the target 32, the deuterium (²D) or tritium (³T) on the target fuses with the ²D and ³T ions to produce neutrons and He-3 (²D-²D fusion) or He-4 (²D-³T) fusion). The neutrons thus generated have an average energy of about 2.5 MeV (²D-²D fusion) or 14.1 MeV (²D-³T fusion). These two types of neutron generators are commonly referred to as d-D and d-T neutron generators.

The d-T neutron generator is a popular neutron generator commonly used in downhole logging tools. On the other hand, the d-D neutron generator has not enjoyed the same wide use because it is difficult to obtain a sufficiently high neutron output with a d-D generator.

The outputs of these electronic neutron sources can be readily controlled by pulses of electrical signals used to generate the neutrons. The electrical control signals may be in the form of voltages, currents, or frequencies, a combination thereof. Thus, these generators are often referred to as pulsed neutron generator (PNG). When using such a pulsed neutron generator, the formation surrounding the well logging instrument is subjected to repeated, discrete “bursts” of neutrons. Being able to control the timing of bursts provides a pulsed neutron generator or an electronic neutron source a big advantage: more measurements are possible with an electronic neutron source than with a chemical neutron source because of the added time dimension.

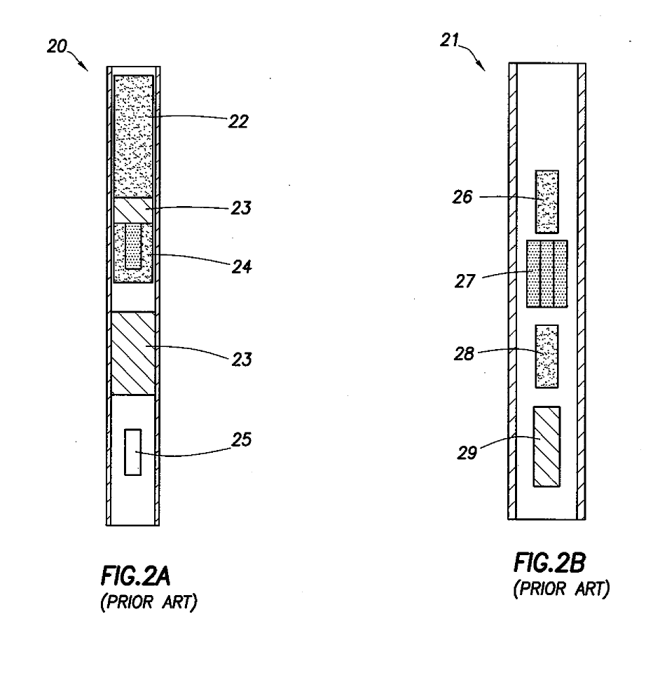

As shown in FIG. 2B, a typical electronic source neutron tool contains a single neutron generator and one or more detectors. In contrast, tools in accordance with embodiments of the invention comprise two electronic neutron sources, one d-D and one d-T generators. Having the ability to simultaneously or sequentially generate 2.4 MeV neutrons from d-D generators and 14.1 MeV neutrons from d-T generators allows a tool of the invention to perform measurements that are impossible or inconvenient with conventional tools. For example, it would be possible to use a tool of the invention to measure neutron porosities using thermal and epithermal measurements and to take advantage of the different response and depths of investigation due to the different energies of the neutrons.

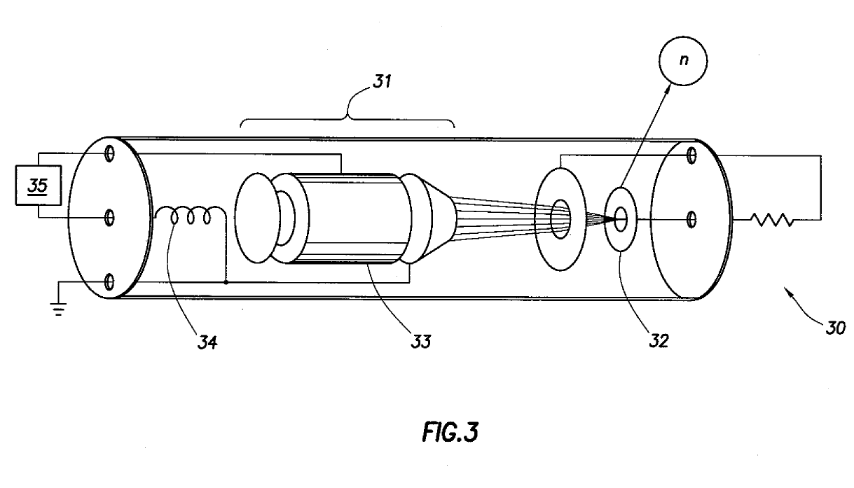

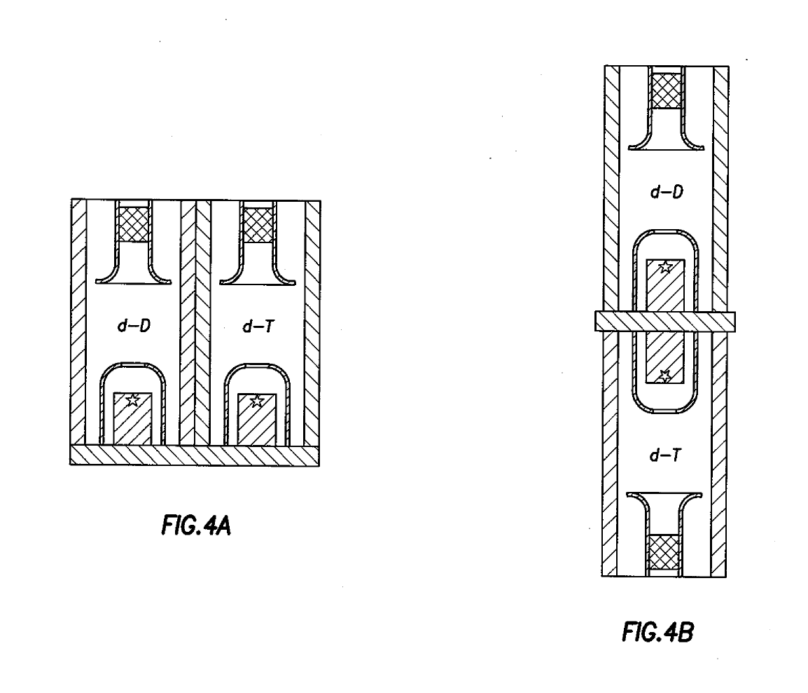

The two electronic neutron generators in a tool may be arranged in different configurations. In some embodiments, the two neutron generators may be collocated in a tool. Two basic arrangements of collocated electronic generators are shown as schematics in FIG. 4A and FIG. 4B. In FIG. 4A, the two neutron generators (d-D and d-T) are arranged in a side-by-side configuration, while in FIG. 4B, the two neutron generators (d-D and d-T) are arranged in a back-to-back configuration. In the side-by-side arrangement (FIG. 4A), the two generators are arranged proximate (or next to) each other and face the same direction. In this arrangement, both generators can share the same high voltage electric field for ion acceleration. In the back-to-back arrangement (FIG. 4B), the two generators are arranged such that the two ionization sources may be located the same positive high-voltage (HV) end and the two targets are arranged at separate negative HV ends.

The configurations shown in FIG. 4A and FIG. 4B are for illustration only. One skilled in the art would appreciate that various modifications are possible without departing from the scope of the invention. For example, the targets may also be connected to grounds, instead of negative HV ends. In addition, the d-D neutron and the d-T neutron generator may use different HV fields or magnetic fields.

An electronic neutron generator or pulsed neutron generator (PNG) is typically operated according to a timing scheme that includes a train of short bursts of neutrons with each burst followed by a duration when the PNG is turned off. For example, U.S. Pat. No. 6,754,586 issued to Adolph et al. discloses several burst timing schemes for formation loggings using a neutron tool. This patent is incorporated by reference in its entirety.

Having two different electronic neutron generators to generate neutrons at different energy levels allows tools of the invention to be used in many unique operations. For example, the two different generators can be simultaneous pulsed while independently adjusting the output of each. Alternatively, these two neutron generators may be pulsed using a scheme that enables one or the other electronic neutron generator in a flexible sequence depending on the requirements of the measurements. These pulsing schemes may be controlled by a control circuit (shown as 35 in FIG. 3). With such control over the pulsing scheme of the two neutron generators, it is possible to achieve any desired mix of d-D (2.4 MeV) and d-T (14.1 MeV) neutrons with accuracy and precision. Each pulsing scheme can be tailored specifically for the type of measurements. In order to control the relative and absolute output of the generator a neutron monitor needs to be used (like the one described in U.S. Pat. No. 6,884,994 or the use described in U.S. Pat. No. 7,073,378)

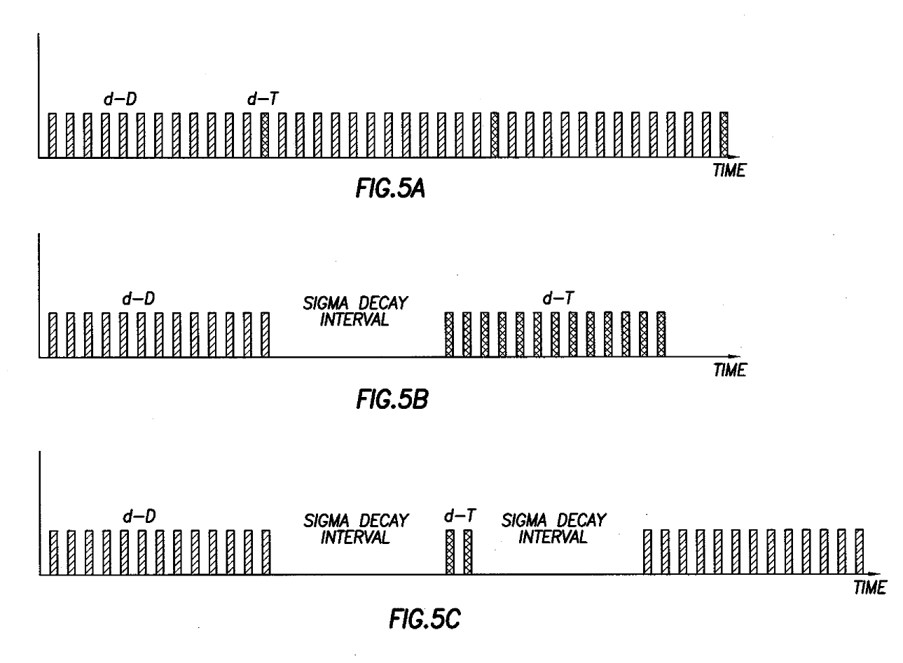

Some examples of pulsing schemes using the two electronic neutron generators are shown in FIGS. 5A-5C. These schematics illustrate how the pulsing scheme can be devised to best utilize the characteristics of both the d-D and d-T neutron generators to make logging downhole more efficiently or to enable operations that are otherwise impossible or inconvenient to perform.

FIG. 5A illustrates a pulsing scheme that uses alternating pulses between d-D and d-T generators. The alternate pulses may be on a pulse-by-pulse basis with each single burst length followed by a decay interval. Alternatively, one neutron generator may be pulsed a few times before pulsing the other neutron generator. This alternate pulsing scheme may be used for porosity measurements. This scheme takes advantage of the high (about 14 MeV) and low (about 2.4 MeV) neutron energies produced. The relative contribution from the d-T and d-D neutron generators may be obtained by using different types of neutron detectors. For example, the high-energy neutrons will be slowed down to epithermal neutron level (e.g., 0.4 eV or higher) and then thermal level (<0.4 eV) less rapidly than the lower energy neutrons (2.4 MeV) from the d-D reaction, while the low energy neutrons (2.4 MeV) are more rapidly slowed downed to the thermal neutron level (less than 0.4 eV).

Furthermore, having neutrons at different energy levels, one can make use of the averaging effects or one can take advantages of the different depths of investigation provided by the different energy neutrons. More importantly, this scheme allows for both the epithermal hydrogen index (HI) measurements and the thermal porosity measurements of a formation at multiple depths of investigation. This provides a significant improvement in that it can save time and money in the logging operation. In addition, this can provide information that is otherwise difficult to obtain.

FIG. 5B shows a different pulsing scheme, in which a longer delay-period is provided between each set of pulses. The delay period (sigma decay interval) would allow one to obtain measurements when the neutron generators are turned off, by observing the die-away of the gamma-ray and/or neutron signal. In addition to being able to calculate the neutron porosity measurements, measurements obtained during such intervals would allow for determination of formation thermal capture cross section and lithology.

The d-T neutron burst sequence may be repeated less frequently due to the relatively higher output of the d-T neutron generator, as compared with the d-D neutron generator, as illustrated in FIG. 5C. This pulsing scheme optimizes the d-D duty cycle, relative to the d-T cycle, such that the outputs of the two generators may be at similar levels. This scheme also illustrates that all bursting trains may be interrupted by a delay interval (Sigma decay interval). These intervals allow measurements to be made without fast neutron interference. Such measurements may be used to determine the formation lithology or formation Sigma (neutron capture cross section).

The pulsing schemes shown in FIGS. 5A-5C are for illustration only. One of ordinary skill in the art would appreciate that various modifications are possible without departing from the scope of the invention. For example, one may also optimize the burst sequence and the duration of each pulse depending on the measurement environment and/or input indication (e.g., borehole or formation information provided by other measurements or calculation).

The unique pulsing schemes that involve both the d-T and d-D neutron generators allow for a wide range of uses for embodiments of the invention. One such measurement is the simultaneous measurement of formation porosity with both high and low energy neutrons. This is made possible because there are neutrons with two distinct energy levels being produced from the same tool. The two types of neutrons each exhibit unique characteristics including the large dynamic range for d-D neutron porosity measurement and the deeper depth of investigation and the density sensitivity of d-T neutron porosity measurement.

Some embodiments of the invention relate to methods for logging the formations using a tool of the invention. As shown in FIG. 6, a method 60 in accordance with one embodiment of the invention includes disposing a nuclear tool in a wellbore penetrating a formation (step 61). The nuclear tool includes both d-D and d-T neutron generators. In addition, the nuclear tool may include one of more nuclear detectors, such as fast neutron detectors, epithermal neutron detectors, thermal neutron detectors, or gamma-ray detectors. Once the tool is lowered to the desired depth, the d-D and/or d-T neutron generators are pulsed to emit neutrons into the formation (step 62). The neutrons thus emitted may have energies of 2.4 MeV (from d-D neutron generator) or 14 MeV (from d-T generator). These neutrons, having different energies, will interact with the nuclei in the formation in different manners. Furthermore, the higher energy neutrons can travel farther into the formation. After interactions with nuclei in the formations, these neutrons lose some of their energies and become epithermal or thermal neutrons. Some of these neutrons may also be captured by the nuclei in the formations. Such interactions may also generate gamma rays. The neutrons or gamma rays that return to the tool will be detected with one or more detectors (step 63). Finally, such measurements may be used to determine various formation properties, such as formation slowing down time, formation porosity, formation neutron capture cross section, formation bulk density, or lithology of the formation (step 64).

Applications of embodiments of the invention, for example, may include dual-energy slowing down time measurements for the emitted neutrons, formation porosity measurements, spectroscopy measurements with or without inelastic gamma-rays, and formation capture cross section (sigma) measurement. More importantly, all these measurements can be made at an average neutron energy level or with multiple depths of investigation, which would not be possible with the conventional tools.

Advantages of the invention may include one or more of the following. A neutron tool in accordance with embodiments of the invention includes two different types of neutron sources. These two different types of sources enable one to probe the formation with neutrons having different energies. This in turn makes it possible to have more accurate measurements of formation properties or investigation of formation properties at different depths into the formation. The two different types of neutron sources may be generated with different pulsing schemes such that the amounts of different neutrons generated can be independently regulated. Neutron tools in accordance with embodiments of the invention may be used in various types of neutron logging operations independent of how the tools are conveyed, including wireline, slick-line, drill-pipe conveyed, tubing conveyed, while-drilling, or while-tripping tools.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A nuclear tool, comprising:
a tool housing;
a d-D neutron generator disposed in the tool housing; and
a d-T neutron generator disposed in the tool housing.

2. The nuclear tool of claim 1, further comprising a control circuit for controlling pulsing of the d-D neutron generator and the d-T neutron generator.

3. The nuclear tool of claim 1, wherein the d-D neutron generator and the d-T neutron generator are arranged in a side-by-side configuration.

4. The nuclear tool of claim 1, wherein the d-D neutron generator and the d-T neutron generator are arranged in a back-to-back configuration.

5. The nuclear tool of claim 1, further comprising at least one detector selected from the group consisting of a thermal neutron detector, an epithermal neutron detector, a fast neutron detector, and a gamma-ray detector.

6. The nuclear tool of claim 1, wherein the d-D neutron generator and the d-T neutron generator targets are configured to operate at a high negative voltage or at ground potential.

7. The nuclear tool of claim 1, further comprising at least one detector to monitor neutron flux from the d-T neutron generator, the d-D neutron generator, or both the d-T neutron generator and the d-D neutron generator.

8. A method for well-logging using a nuclear tool, comprising:
disposing the nuclear tool in a wellbore penetrating a formation;
pulsing a d-D neutron generator to emit neutrons at a first energy level into the formation;
pulsing a d-T neutron generator to emit neutrons at a second energy level into the formation; and
measuring signals returning from the formation

9. The method of claim 8, wherein the pulsing of the d-D neutron generator and the pulsing of the d-T neutron generator are adjusted such that outputs from the d-D neutron generator and outputs from the d-T neutron generator are substantially the same.

10. The method of claim 8, wherein the pulsing of the d-D neutron generator and the pulsing of the d-T neutron generator are performed according to a specific pulsing scheme.

11. The method of claim 10, wherein the specific pulsing scheme include at least one period when no neutron output is generated.

12. The method of claim 8, wherein the signals include neutron signals and gamma-ray signals.

13. The method of claim 8, further comprising deriving at least one formation property from the detected signals.

14. A method for constructing a neutron tool, comprising:
disposing a d-D neutron generator inside a tool housing; and
disposing a d-T neutron generator inside the tool housing.

15. The method of claim 14, wherein the d-D neutron generator and the d-T neutron generator are positioned side-by-side.

16. The method of claim 14 wherein the d-D neutron generator and the d-T neutron generator are positioned back-to-back.
